(19) United States
(12) Patent Application Publication
(10) Pub. No.: US 2026/0029815 A1
(43) Pub. Date: Jan. 29, 2026

(54) COMPUTING SYSTEM AND METHOD FOR PROCESSING PHOTONIC COMPUTING RESULT

(71) Applicant: Nanjing Guangzhiyuan Technology Co., Ltd., Nanjing, Jiangsu (CN)

(72) Inventors: Yichen SHEN, Nanjing, Jiangsu (CN); Huaiyu MENG, Nanjing, Jiangsu (CN); Shiyue HUA, Nanjing, Jiangsu (CN)

(73) Assignee: Nanjing Guangzhiyuan Technology Co., Ltd., Nanjing, Jiangsu (CN)

(21) Appl. No.: 18/994,103

(22) PCT Filed: Jul. 5, 2023
(86) PCT No.: PCT/CN2023/105976

§ 371 Date: Jan. 14, 2025

(30) Foreign Application Priority Data
Jul. 15, 2022 (CN) 202210831670.2

(51) Int. Cl. G06E 3/00

(52) U.S. Cl. CPC G06E 3/005

(57) ABSTRACT

Disclosed is a computing system and a method for processing a photonic computing result. The method includes: generating a first optical signal, wherein the first optical signal represents first data; performing a first computation on the first optical signal in a photonic domain to obtain a second optical signal representing a computation result; establishing a corresponding relationship between a theoretical mathematical result of the first computation and the second optical signal; and storing the theoretical mathematical result and a parameter of the corresponding second optical signal.

This application claims priority to Chinese Patent Application No. 202210831670.2 filed with CNIPA on Jul. 15, 2022, and entitled “COMPUTING SYSTEM AND METHOD FOR PROCESSING PHOTONIC COMPUTING RESULT”. The disclosure of the aforementioned application is incorporated herein by reference in its entirety.

### TECHNICAL FIELD

The present application relates to the field of computing, and more specifically, to a computing system and a method for processing a photonic computing result.

### BACKGROUND

In a photonic computing, at least part of the computation is performed in a photonic domain to obtain an output signal, based on which a mathematical result of the computation is obtained. The inventors have found that in a practical photonic computing system, there may be errors in the manufacturing of a photonic computing device, or an actual output signal may not align with its intended design, or an output result may have a complex relationship with an input. As a result, when a computation result is output, the output signal may deviate from an expected signal, or it may be difficult to accurately predict the output signal.

### TECHNICAL SOLUTIONS

Embodiments of the present application provide a computing system and a method for processing a photonic computing result.

In some exemplary embodiments, a method for processing a photonic computing result is provided, including: generating a first optical signal, wherein the first optical signal represents first data; performing a first computation on the first optical signal in a photonic domain to obtain a second optical signal representing a computation result; establishing a corresponding relationship between a theoretical mathematical result of the first computation and the second optical signal; and storing the theoretical mathematical result and a parameter of the corresponding second optical signal.

In some embodiments, the generation of the first optical signal includes: modulating an initial optical signal to generate the first optical signal.

In some embodiments, the first computation includes at least one of multiplication and addition.

In some embodiments, the first computation includes performing multiplication and addition in sequence.

In some embodiments, the first data includes a plurality of input values.

In some embodiments, a parameter of the second optical signal includes at least one of intensity, polarization, and phase of light.

In some exemplary embodiments, a method for processing a photonic computing result is provided, including: generating a first optical signal, wherein the first optical signal represents first data; performing a first computation on the first optical signal in a photonic domain to obtain a second optical signal representing a computation result; converting the second optical signal into a second electrical signal; establishing a corresponding relationship between a theoretical mathematical result of the first computation and the second electrical signal; and storing the theoretical mathematical result and a parameter of the corresponding second electrical signal.

In some embodiments, a parameter of the second electrical signal includes at least one of a voltage parameter and a current parameter.

In some exemplary embodiments, a method includes: generating a first optical signal, wherein the first optical signal represents first data; performing a first computation on the first optical signal in a photonic domain to obtain a second optical signal; performing, after a photoelectric conversion of the second optical signal, a second computation in an electronic domain, to obtain an electrical signal representing a theoretical mathematical result of the second computation; and storing the theoretical mathematical result and a parameter of the corresponding electrical signal.

In some embodiments, the first computation includes multiplication.

In some embodiments, the second computation includes addition.

In some exemplary embodiments, a computing system is provided, including: an optical encoding unit configured to generate a first optical signal based on first data by encoding; a photonic computing unit configured to perform a first computation on the first optical signal in a photonic domain to obtain a second optical signal representing a computation result of the first computation; and a storage unit configured to store a theoretical mathematical result of the first computation and a parameter of the corresponding second signal.

In some embodiments, the second signal is a second optical signal.

In some embodiments, the second signal is a second electrical signal obtained by performing a photoelectric conversion on the second optical signal.

In some embodiments, the photonic computing unit includes a photoelectric conversion unit for converting the second optical signal into the second electrical signal.

In some exemplary embodiments, a computing system includes: an optical encoding unit configured to generate a first optical signal based on first data by encoding; a photonic computing unit configured to perform a first computation on the first optical signal in a photonic domain to obtain a second signal representing a computation result of the first computation; an electronic computation unit configured to obtain a second signal and perform a second computation on the second signal in an electronic domain to obtain an electrical signal representing a computation result of the second computation; and a storage unit configured to store a theoretical mathematical result of the second computation and a parameter of the corresponding electrical signal.

In some embodiments, the second signal is a second optical signal, the electronic computing unit includes a photoelectric conversion unit configured to convert the second optical signal into an electrical signal, so as to perform the second computation in the electronic domain.

In some embodiments, the second signal is a second electrical signal, and the photonic computing unit comprises a photoelectric conversion unit configured to perform a photoelectric conversion on an optical result of the first computation performed in the photonic domain, to obtain the second electrical signal to perform the second computation in the electronic domain.

In some embodiments, the photoelectric conversion unit includes a photodiode.

In some embodiments, the parameter of the electrical signal corresponding to the theoretical mathematical result are selected from a current parameter and a voltage parameter.

In a scene where a photonic computation is involved, the invention proposes to establish a corresponding relationship between a theoretical mathematical result and an actual output signal, so that in a practical computation, the corresponding relationship may be used to obtain or interpret, based on the output signal, whether it represents a real numerical value, and may further be used to analyse an error in the manufacture of a photonic computing device, or study input and output characteristics of a photonic computing device.

Various aspects, features, advantages, etc., of the embodiments of the present disclosure will be described in detail below with reference to the accompanying drawings. The above aspects, features, advantages, etc., of the present disclosure will become clearer from the following detailed description in conjunction with the accompanying drawings.

Various aspects, features, advantages, etc., of the embodiments of the present disclosure will be described in detail below with reference to the accompanying drawings. The above aspects, features, advantages, etc., of the present disclosure will become clearer from the following detailed description in conjunction with the accompanying drawings.

Refer to the following description and to the accompanying drawings, specific embodiments of the present disclosure are disclosed in detail and the manner in which the principles of the present disclosure may be employed is illustrated. It should be understood that embodiments of the present disclosure are not thereby limited in scope. Embodiments of the present disclosure include numerous changes, modifications, and equivalents, within the spirit and scope of the appended claims.

Features described and/or illustrated with respect to one embodiment may be used in the same or similar manner in one or more other embodiments, combined with features in the other embodiments, or in place of features in the other embodiments.

It should be emphasized that the term “comprising” when used herein refers to the presence of features, integers, steps, or components, but does not exclude the presence or addition of one or more other features, integers, steps, or components.

### BRIEF DESCRIPTION OF THE DRAWINGS

In order to more clearly illustrate the technical solutions in the embodiments of the present disclosure, the drawings needed to be used in the description of the embodiments will be briefly introduced below. Apparently, the drawings in the following description are only some embodiments of the present disclosure. For those skilled in the art, other drawings may also be obtained based on these drawings without exerting creative efforts.

FIG. 1 shows a method for processing a photonic computing result.

FIG. 2 shows a schematic diagram of a computing system according to some embodiments.

FIGS. 3a and 3b show schematic diagrams of a computing system according to some embodiments.

FIG. 4 shows a schematic diagram of a computing system according to some embodiments.

### EMBODIMENTS OF THE INVENTION

In order to facilitate understanding of various aspects, features and advantages of the technical solution of the present disclosure, the present disclosure is described in detail below with reference to the accompanying drawings. It should be understood that the various embodiments described below are only for illustration and are not intended to limit the scope of the present disclosure.

The terminology used in the present disclosure is for the purpose of describing particular embodiments only and is not intended to limit the disclosure. As used herein, singular forms “a,” “an,” and “the” are intended to include the plural forms as well, unless the context clearly indicates otherwise. It will be further understood that the terms “comprising” and/or “including” when used in the description specify the presence of stated features, integers, steps, operations, elements and/or parts, but do not exclude the presence or addition of one or more other features, integers, steps, operations, elements, components and/or groups thereof. As used herein, the term “and/or” includes any and all combinations of one or more of associated items having been listed, and the phrase “at least one of A and B” refers to only A, only B, or both A and B. In the present disclosure, the chip may include a die. In the present disclosure, features of one embodiment may also be applied to and appropriately incorporated as the features of other embodiments described in this disclosure.

The present disclosure provides a method for processing a photonic computing result, which may establish a corresponding relationship between a parameter of an output signal, which is obtained through a photonic computation, and a theoretical result, and store the corresponding relationship, thereby optimizing the photonic computing. When a computation is to be performed, a corresponding result (mathematical meaning) of an output signal may be obtained based on this corresponding relationship.

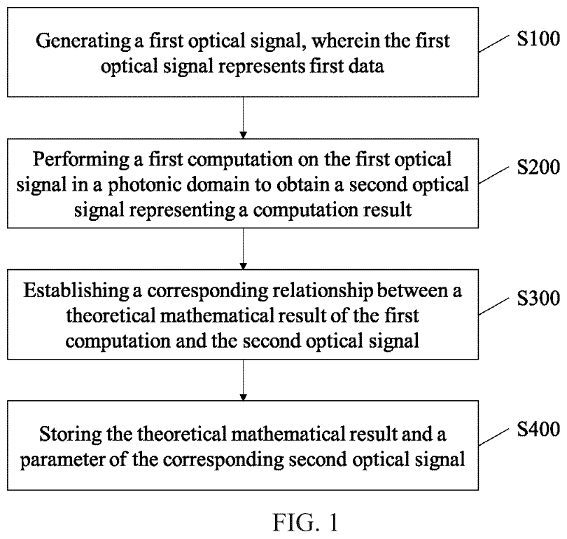

As shown in FIG. 1, a method is provided, including:
in S100, generating a first optical signal, wherein the first optical signal represents first data;
in S200, performing a first computation on the first optical signal in a photonic domain to obtain a second optical signal representing a computation result;
in S300, establishing a corresponding relationship between a theoretical mathematical result of the first computation and the second optical signal; and
in S400, storing the theoretical mathematical result and a parameter of the corresponding second optical signal.

The computation on the first optical signal in the photonic domain may be performed in a photonic computing system, more specifically, in a photonic computing unit. The photonic computing system may include: a photonic computing unit configured to receive the first optical signal, where the first optical signal represents the first data; and the photonic computing unit may perform the computation on the first optical signal in the photonic domain. An exemplary photonic computing unit may include a weight module (also referred to as a multiplication module) configured to represent second data. The photonic computing unit may further include an addition module, which may, for example, perform an addition operation in the photonic domain.

In some embodiments, there may be a plurality of first optical signals to represent a plurality of first data to be computed, respectively. For example, the plurality of first optical signals may respectively represent a plurality of elements of a vector, and there may be a plurality of weight modules to represent a plurality of elements of a matrix, respectively. Therefore, a matrix-vector multiplication may be performed, so that a plurality of optical signals are output.

In some exemplary embodiments, the photonic computing system may further include computations performed in an electronic domain. For example, the photonic computing system may perform multiplication in the photonic domain and perform addition in the electronic domain.

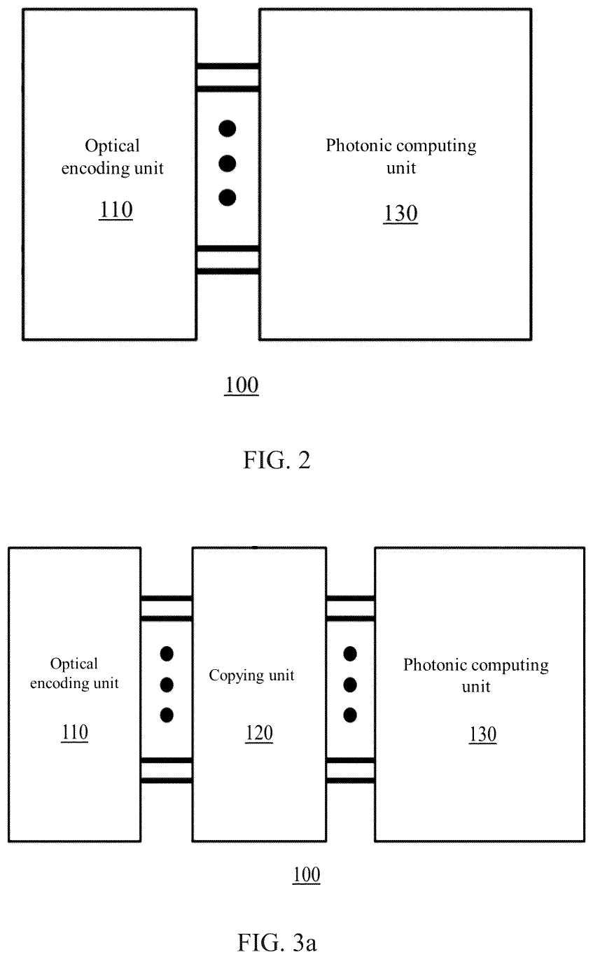

FIG. 2 shows a computing system 100, which includes a part for performing the computations in the photonic domain. More specifically, the computing system 100 is a photonic computing system, specifically, including an optical encoding unit 110 and a photonic computing unit 130.

In the operation S100, an initial optical signal may be encoded by the optical encoding unit 110. For example, the initial optical signal is encoded based on the first data to be converted into the first optical signal representing the first data, thereby generating the first optical signal.

In the operation S200, the photonic computing may be performed by the photonic computing unit 130. The photonic computing unit 130 may perform the computation in the photonic domain based on the first optical signal generated by the optical encoding unit 110. That is, mathematical computations are performed with the optical signal representing data information. The photonic computing unit 130 may use optical signals to perform, for example, multiplication, addition, matrix and vector computations, etc.

In the operation S300, for example, the first computation is multiplication, the first data includes an input value x=5 to be computed, and the weight module (the multiplication module) corresponds to another multiplier y=3, hence, the theoretical mathematical result of the first computation should be z=3×5=15. The first optical signal represents the first data x=5, and the weight module in the photonic computing unit is set to 3. For example, the weight module may be set to 3 through an electrical signal, and after the photonic computing is performed in the photonic domain through the weight module, the second optical signal is output, and a parameter of the second optical signal, such as a light intensity parameter, may be obtained. Further, the corresponding relationship between the parameter of the second optical signal and the theoretical mathematical result, which is 15, may be established.

In the operation S400, the theoretical mathematical result may be stored by a storage unit. For example, the theoretical mathematical result is 15, and the parameter of the corresponding optical signal is the light intensity P0, in such case, 15 and the corresponding P0 are stored. In this way, the corresponding relationship between the computed output signal and an exact value (i.e., the theoretical mathematical result) represented by the output signal may be established and stored. In subsequent computations, a value corresponding to an output signal may be restored based on the output signal and the corresponding relationship. In some embodiments, the parameter of the optical signal may include an intensity, a phase, a frequency, etc. The above parameter(s) of the optical signal may be obtained by using a photoelectric conversion unit to convert the optical signal into an electrical signal for measurement.

For example, the first computation includes at least one of multiplication and addition.

For example, the first computation includes performing multiplication and addition in sequence (i.e., performing multiplication first, then performing addition).

In some embodiments, the first data includes a plurality of input values. According to computation requirements, the first optical signal may be one or more optical signals, the first data may be one or more numerical values, and the second optical signal may also be one or more optical signals.

In some embodiments, the parameter of the second optical signal include at least one of intensity, polarization, and phase of light.

In some embodiments, the computing system may include a copying unit.

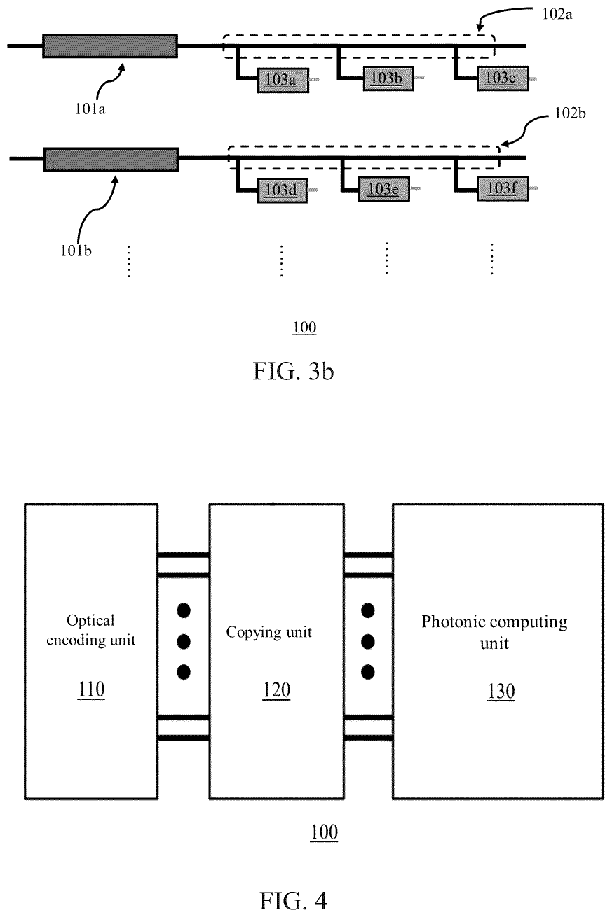

For example, FIG. 3a shows a computing system 100, which includes a part for performing computations in the photonic domain. The computing system 100 is a photonic computing system, and specifically, includes an optical encoding unit 110, a copying unit 120, and a photonic computing unit 130.

For example, the optical encoding unit may include multiple modulators, and the modulators may encode light based on data. FIG. 3b shows modulators 101a and 101b in the optical encoding unit. The optical encoding unit is optically connected to the copying unit. The copying unit may include one or more copying modules. The copying module may include a beam splitter, which may split a beam of light, which has been inputted into the copying module, into two or more beams of light, that is, performing “copying”. In this way, one or more optical copies may be generated, and the optical copies may be used as the first optical signal. FIG. 3b shows copying modules 102a and 102b in the copying unit. The computing system further includes the photonic computing unit configured to receive the first optical signal, wherein the first optical signal represents the first data. The photonic computing unit includes a plurality of weight modules, wherein the weight modules may also be referred to as multiplication modules. As an example, each of the weight modules 103a, 103b, 103c, 103d, 103e, and 103f in FIG. 3b may correspond to one numerical value, and are configured to perform multiplication on one numerical value corresponding to one optical signal and one numerical value corresponding to one weight module. For example, the numerical value represented by the weight module may be changed through an electrical signal. The output signal of the copying module does not necessarily have the same amplitude as that of an input signal. For example, if an optical beam splitter (an optical power splitter) is used to evenly split the input signal power into two output signals, each of the two output signals will have a power equal to or less than 50% of the power of the input signal.

In some cases, the copying module or the optical encoding unit may be omitted, and an optical signal carrying data may be directly input into the photonic computing unit through some optical ports. In addition, an optical signal output by the optical encoding unit may be directly input into the photonic computing unit. In some embodiments, a photonic integrated circuit may be used to implement an photonic computing unit. For example, the photonic computing unit may be included in the photonic integrated circuit chip, and optical signals may be input or output through optical ports (such as grating couplers and end face couplers) on the photonic integrated circuit chip.

The optical encoding unit may encode light to allow an optical signal to represent a numerical value. The encoded optical signal may be input into the photonic computing unit as a data source for computations. For example, the optical encoding unit may encode n numerical values to generate n corresponding optical signals. For example, the photonic computing unit includes a plurality of weight modules, and the n optical signals may be respectively input into n corresponding weight modules of the plurality of weight modules for computation. The optical encoding unit may include, for example, a plurality of modulators, and each modulator may modulate light based on an electrical signal representing a numerical value, thereby encoding and generating the initial optical signals. In addition to the above-mentioned photonic computing unit, the photonic computing system may include other photonic computing units, such as a second photonic computing unit and a third photonic computing unit. Computing modules in different photonic computing units may be different, and may implement different functions.

In addition to the plurality of weight modules mentioned above (which are configured to correspond to a plurality of numerical values), the photonic computing unit may further include other structures or photonic computing modules that may realize photonic computing, such as a photonic computing module that uses Mach-Zehnder interferometer (MZI) to perform computations.

In some exemplary embodiments, a method is provided, including: generating a first optical signal, wherein the first optical signal represents first data; performing a first computation on the first optical signal in a photonic domain to obtain a second optical signal representing a computation result; converting the second optical signal into a second electrical signal; establishing a corresponding relationship between a theoretical mathematical result of the first computation and the second electrical signal; and storing the theoretical mathematical result and a parameter of the corresponding second electrical signal.

In some embodiments, a parameter of the second electrical signal may include a voltage, a current, etc. The second electrical signal may be obtained by converting the second optical signal through a photoelectric conversion unit. In some cases, parameters of an optical signal are difficult to be directly obtained, but it may be easier to obtain the parameters by storing the parameters of the second electrical signal obtained through a photoelectric conversion.

In some embodiments, the computing system may include an electronic computing unit.

For example, in FIG. 4, compared to the embodiment of FIG. 3a, the computing system 100 may further include an electronic computing unit 140. In FIG. 4, the computing system includes: an optical encoding unit 110 configured to generate a first optical signal based on first data by encoding; a photonic computing unit 130 configured to perform a first computation on the first optical signal in a photonic domain to obtain a second signal representing a computation result; and the electronic computing unit 140 configured to obtain the second signal, and perform a second computation on the second signal in the electronic domain, to obtain an electrical signal representing a theoretical mathematical result of the second computation. Optionally, the computing system 100 may further include a copying unit 120.

In some embodiments, the second signal is a second optical signal, and the electronic computing unit includes a photoelectric conversion unit configured to convert the second optical signal into an electrical signal, so as to perform the second computation in the electronic domain.

In some embodiments, the second signal is a second electrical signal, and the photonic computing unit includes a photoelectric conversion unit configured to perform a photoelectric conversion on an optical result of the first computation performed in the photonic domain, to obtain the second electrical signal, so as to perform the second computation in the electronic domain.

In some embodiments, the photoelectric conversion unit includes a photodiode.

In some embodiments, a parameter of the electrical signal corresponding to the theoretical mathematical result is selected from a current parameter and a voltage parameter.

In some exemplary embodiments, a method is provided, including: generating a first optical signal, wherein the first optical signal represents first data; performing a computation on the first optical signal in a photonic domain to obtain a second optical signal; performing, after a photoelectric conversion of the second optical signal, a second computation in an electronic domain, to obtain an electrical signal representing the theoretical mathematical result of the second computation; and storing the theoretical mathematical result and a parameter of the corresponding electrical signal.

In some embodiments, the first computation includes multiplication.

In some embodiments, the second computation includes an addition computation.

Those skilled in the art should understand that the above disclosure is merely some implementation modes of the present disclosure, and cannot be used to limit the protection scope of claimed by the present disclosure. Equivalent changes made according to the implementation modes of the present disclosure will fall into the scope defined by claims of the present disclosure.

1. A method for processing a photonic computing result, comprising:
generating a first optical signal, wherein the first optical signal represents first data;
performing a first computation on the first optical signal in a photonic domain to obtain a second optical signal representing a computation result;
establishing a corresponding relationship between a theoretical mathematical result of the first computation and the second optical signal; and
storing the theoretical mathematical result and a parameter of the corresponding second optical signal.

2. A method for processing a photonic computing result, comprising:
generating a first optical signal, wherein the first optical signal represents first data;
performing a first computation on the first optical signal in a photonic domain to obtain a second optical signal representing a computation result;
converting the second optical signal into a second electrical signal;
establishing a corresponding relationship between a theoretical mathematical result of the first computation and the second electrical signal; and
storing the theoretical mathematical result and a parameter of the corresponding second electrical signal.

3. The method according to claim 1, wherein the generation of the first optical signal comprises: modulating an initial optical signal to generate the first optical signal.

4. The method according to claim 1, wherein the first computation comprises at least one of multiplication and addition.

5. The method according to claim 1, wherein the first computation comprises performing multiplication and addition in sequence.

6. The method according to claim 1, wherein the first data comprises a plurality of input values.

7. The method according to claim 1, wherein a parameter of the second optical signal comprises at least one of intensity, polarization, and phase of light.

8. The method of claim 2, wherein a parameter of the second electrical signal comprises at least one of a voltage parameter and a current parameter.

9. A computing system comprising:
an optical encoding unit configured to generate a first optical signal based on first data by encoding;
a photonic computing unit configured to perform a first computation on the first optical signal in a photonic domain to obtain a second optical signal representing a computation result of the first computation; and
a storage unit configured to store a theoretical mathematical result of the first computation and a parameter of the corresponding second signal.

10. The computing system of claim 9, wherein the second signal is a second optical signal.

11. The computing system of claim 9, wherein the second signal is a second electrical signal obtained by performing a photoelectric conversion on the second optical signal.

12. The computing system of claim 11, wherein the photonic computing unit comprises a photoelectric conversion unit for converting the second optical signal into the second electrical signal.

13. A computing system, comprising:
an optical encoding unit configured to generate a first optical signal based on first data by encoding;
a photonic computing unit configured to perform a first computation on the first optical signal in a photonic domain to obtain a second signal representing a computation result of the first computation;
an electronic computation unit configured to obtain a second signal and perform a second computation on the second signal in an electronic domain to obtain an electrical signal representing a computation result of the second computation; and
a storage unit configured to store a theoretical mathematical result of the second computation and a parameter of the corresponding electrical signal.

14. The computing system of claim 13, wherein the second signal is a second optical signal, the electronic computing unit comprises a photoelectric conversion unit configured to convert the second optical signal into an electrical signal, so as to perform the second computation in the electronic domain.

15. The computing system of claim 13, wherein the second signal is a second electrical signal, and the photonic computing unit comprises a photoelectric conversion unit configured to perform a photoelectric conversion on an optical result of the first computation performed in the photonic domain, to obtain the second electrical signal to perform the second computation in the electronic domain.

16. The computing system of claim 14, wherein the photoelectric conversion unit comprises a photodiode.

17. The computing system of claim 14, wherein the parameter of the electrical signal corresponding to the theoretical mathematical result are selected from a current parameter and a voltage parameter.

18. A method for processing a photonic computing result, comprising:
generating a first optical signal, wherein the first optical signal represents first data;
performing a first computation on the first optical signal in a photonic domain to obtain a second optical signal;
performing, after a photoelectric conversion of the second optical signal, a second computation in an electronic domain, to obtain an electrical signal representing a theoretical mathematical result of the second computation; and
storing the theoretical mathematical result and a parameter of the corresponding electrical signal.

19. The method of claim 18, wherein the first computation comprises multiplication.

20. The method of claim 19, wherein the second computation comprises addition.
